(19) United States
(12) Patent Application Publication
(10) Pub. No.: US 2010/0171874 A1
(43) Pub. Date: Jul. 8, 2010

(54) Apparatus and method for photographing image in portable terminal

(75) Inventors: Ji-Hyun Park, Seoul (KR); Jong-Ho Park, Yongin-si (KR); Kun-Hak Lee, Hwaseong-si (KR); Je-Han Yoon, Seongnam-si (KR); Yong-Jin Choi, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/655,681

(22) Filed: Jan. 5, 2010

(30) Foreign Application Priority Data
Jan. 5, 2009 (KR) 10-2009-0000310

(51) Int. Cl. H04N 5/238

(52) U.S. Cl. 348/369; 348/E05.04

(57) ABSTRACT

A portable terminal includes an apparatus for photographing an image. The portable terminal can receive an image via a camera and recognize the received image through an image recognition process. The portable terminal can determine a photographing composition corresponding to the recognition result, and adjust an angle of the camera depending on the determined photographing composition.

### CROSS-REFERENCE TO RELATED APPLICATION(S) AND CLAIM OF PRIORITY

The present application claims is related to and priority under 35 U.S.C. §119(a) to a Korean Patent Application filed in the Korean Intellectual Property Office on Jan. 5, 2009 and assigned Serial No. 10-2009-0000310, the contents of which are herein incorporated by reference.

### TECHNICAL FIELD OF THE INVENTION

The present invention relates to an apparatus and method for photographing an image in a portable terminal. More particularly, the present invention relates to an apparatus and method for photographing an image using a panning/tilting function in a portable terminal.

### BACKGROUND OF THE INVENTION

The recent miniaturization, lightness, and slimness of portable terminals lead to an increase of a convenience of portability, thus gradually increasing a demand for the portable terminals. Therefore, even supplementary functions loaded in the portable terminals are diversified.

Particularly, with the recent rapid increase of a public concern over image photographing, a trend exists to include a digital camera function in most portable terminals. Beyond simple image photographing, users require a higher service. Accordingly, in addition to a simple photography function, a digital camera provides various visual effects, an image editing function, and the like to meet users' demands. For example, the digital camera provides a function of size adjustment for a photographed image, quality adjustment, lighting adjustment, flash, background decoration, special effects, and the like. However, the conventional functions have limits in acquiring an image of a higher quality desired by a user.

In the case of taking a photograph using a composition suitable to a subject intended for photographing, a user having some interests in photography is aware that he/she can acquire a photograph of a higher quality. For example, the user can acquire a photograph of a high quality if he/she photographs using a three-equal-part composition when a subject is a character, and if he/she photographs using an ‘S’-shaped composition when the subject is a winding path or river.

However, most general users are well not aware which composition is suitable to a subject that they themselves intend to photograph. Additionally, it is rare that the users taking a photograph to have thoughts of a composition suitable to a subject whenever taking a photograph. That is, the conventional art has a disadvantage that it is difficult to acquire a photograph of a high quality because most of users position a subject in a center of a screen to take a photograph.

### SUMMARY OF THE INVENTION

To address the above-discussed deficiencies of the prior art, it is a primary aspect of the present invention is to substantially solve at least the above problems and/or disadvantages and to provide at least the advantages below. Accordingly, one aspect of the present invention is to provide an apparatus and method for photographing an image in a portable terminal.

Another aspect of the present invention is to provide an apparatus and method for photographing an image using a panning/tilting function of a camera in a portable terminal.

A further aspect of the present invention is to provide an apparatus and method for automatically determining a photographing composition and photographing an image in a portable terminal.

The above aspects are achieved by providing an apparatus and method for photographing an image in a portable terminal.

According to one aspect of the present invention, a method for photographing an image in a portable terminal is provided. The method includes receiving an image from a camera, recognizing the received image through an image recognition process, determining a photographing composition corresponding to the recognition result, and adjusting an angle of the camera depending on the determined photographing composition.

According to another aspect of the present invention, an apparatus for photographing an image in a portable terminal is provided. The apparatus includes a camera, a controller, and an adjustment unit. The camera receives an image. The controller recognizes the received image through an image recognition process and determines a photographing composition corresponding to the recognition result. The adjustment unit adjusts an angle of the camera depending on the determined photographing composition.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts::

FIG. 1 illustrates a construction of a portable terminal according to an exemplary embodiment of the present invention;

FIG. 2 illustrates a procedure of photographing an image in a portable terminal according to an exemplary embodiment of the present invention;

FIGS. 3A and 3B illustrate a picture composition for a photographed image in a portable terminal according to an exemplary embodiment of the present invention;

FIGS. 4A and 4B illustrate a picture composition for a photographed image in a portable terminal according to another exemplary embodiment of the present invention; and

FIGS. 5A and 5B illustrate a picture composition for a photographed image in a portable terminal according to a further exemplary embodiment of the present invention.

### DETAILED DESCRIPTION OF THE INVENTION

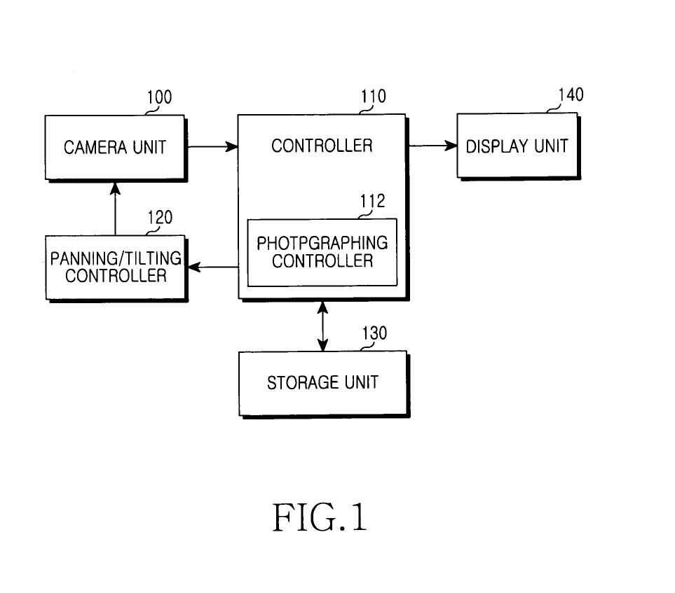

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

An apparatus and method for photographing an image using a panning/tilting function of a camera in a portable terminal according to an exemplary embodiment of the present invention are described below. Here, the panning/tilting function of the camera represents a function of adjusting a sensor angle of a camera up/down/left/right.

FIG. 1 illustrates a construction of a portable terminal according to an exemplary embodiment of the present invention.

Referring to FIG. 1, the portable terminal includes a camera unit 100, a controller 110, a panning/tilting controller 120, a storage unit 130, and a display unit 140.

The camera unit 100 includes a camera sensor (not shown) and a signal processor (not shown). The camera sensor (not shown) converts an optical signal sensed at the time of image photographing into an electric signal. The signal processor (not shown) converts an analog image signal photographed from the camera sensor (not shown) into digital data and provides the digital data to the controller 110. Here, the camera sensor can be a Charge Coupled Device (CCD) sensor, and the signal processor can be a Digital Signal Processor (DSP). Particularly, the camera unit 100 is adjusted in its panning angle and tilting angle under control of the panning/tilting controller 120 according to the present invention. Here, the panning angle denotes an extent of moving a camera sensor angle left/right, and the tilting angle denotes an extent of moving the camera sensor angle up/down.

The controller 110 performs a process and control for a general operation of the portable terminal, processes an image signal received from the camera unit 100 in a unit of a frame, and outputs the processed image signal adaptive to a characteristic and size of the display unit 140. The controller 110 also includes an image codec (not shown) and performs functions of coding an image signal in a set scheme or decoding coded frame image data into the original frame image data.

The controller 110 includes a photographing controller 112 according to the present invention. Thus, the controller 110 recognizes a subject in an image signal frame through an image recognition algorithm, determines a photographing composition suitable to the recognized subject, determines a panning angle and tilting angle for moving the camera sensor of the camera unit 100, and provides the determined panning angle and tilting angle to the panning/tilting controller 120. For example, when the subject is a character as the image recognition result, the photographing controller 112 can determine a three-equal-part composition. The photographing controller 112 sets a position of the character in the determined three-equal-part composition and determines an angle adjustment value of the camera sensor to shift the character to the set position. Here, the angle adjustment value of the camera sensor can be obtained through a distance and angle between a current position of the character in an image frame and the set position.

Particularly, if the subject is a character, the photographing controller 112 determines a photographing composition to have a blank space depending on a face direction of the character and determines the panning angle and tilting angle. Here, the image recognition algorithm can be a variety of existing algorithms. For example, the photographing controller 112 can recognize the subject through an outline extraction algorithm.

The panning/tilting controller 120 adjusts a panning angle and tilting angle of the camera sensor included in the camera unit 100 according to the determined panning angle and tilting angle provided from the controller 110.

The storage unit 130 stores a program for a general operation of the portable terminal and various kinds of data. Particularly, according to the present invention, the storage unit 130 stores a program and data for determining a photographing composition depending on a subject that is a photographing object. For example, the storage unit 130 can store a table representing a mapping relationship between the subject that is the photographing object and the photographing composition.

The display unit 140 displays state information generated during an operation of the portable terminal, numerals, characters, moving pictures, still pictures, and so forth. Particularly, the display unit 140 receives from the controller 110 an image frame corresponding to an image signal input through the camera unit 100 and displays the image frame.

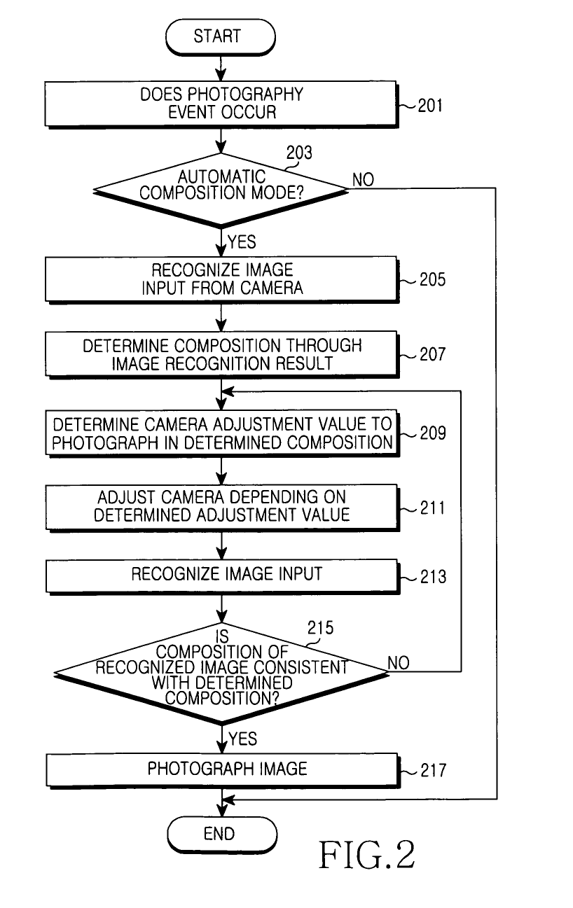

FIG. 2 illustrates a procedure of photographing an image in a portable terminal according to an exemplary embodiment of the present invention.

Referring to FIG. 2, if a photography event occurs in step 201, the portable terminal proceeds to step 203 and checks if an automatic composition mode is set. That is, upon photographing, the portable terminal checks if an automatic composition mode for, in the portable terminal itself, determining a photographing composition and photographing a subject is set. If the automatic composition mode is not set, the portable terminal terminates the procedure according to the exemplary embodiment of the present invention.

If the automatic composition mode is set, the portable terminal proceeds to step 205 and recognizes an image input from a camera through an image recognition algorithm and then, in step 207, determines a photographing composition by way of the image recognition result. Namely, the portable terminal recognizes a subject to be photographed through the image recognition algorithm and then, determines a capturing composition suitable to the recognized subject. For example, if the subject is a character as the image recognition result, the portable terminal can determine the photographing composition as a three-equal-part composition or a triangle composition. If the subject is a winding road or river, the portable terminal can determine the photographing composition as an ‘S’-shaped composition. Particularly, if the subject is the character, the portable terminal determines the photographing composition to have a blank space depending on a face direction of the character and determines a panning angle and a tilting angle. For example, if the subject is the character and a face of the character directs to the left, the portable terminal can determine the photographing composition as the three-equal-part composition and set such that, in the three-equal-part composition, the character is positioned at a right side of an image and a blank space exists at a left side of the image.

Then, in step 209, in order to photograph a subject in the determined photographing composition, the portable terminal determines a panning/tilting angle adjustment value for adjusting a panning/tilting angle of a camera sensor and, in step 211, depending on the determined adjustment value, adjusts the panning/tilting angle of the camera sensor. Here, the portable terminal can also adjust a degree of zoom-in/out depending on the determined photographing composition and a size of the subject.

Then, in step 213, the portable terminal recognizes an image input through the camera of the adjusted panning/tilting angle. Then, in step 215, the portable terminal checks if a photographing composition of the recognized image is consistent with the determined photographing composition. If the photographing composition of the recognized image is not consistent with the determined photographing composition, the portable terminal returns to step 209 and again performs subsequent steps.

If the photographing composition of the recognized image is consistent with the determined photographing composition, in step 217, the portable terminal performs image photographing and terminates the procedure according to the exemplary embodiment of the present invention. Here, the portable terminal can also lead a user to input an image photographing button by displaying a message of informing the user of a completion of automatic composition setting, and can also automatically perform image photographing without a user's input.

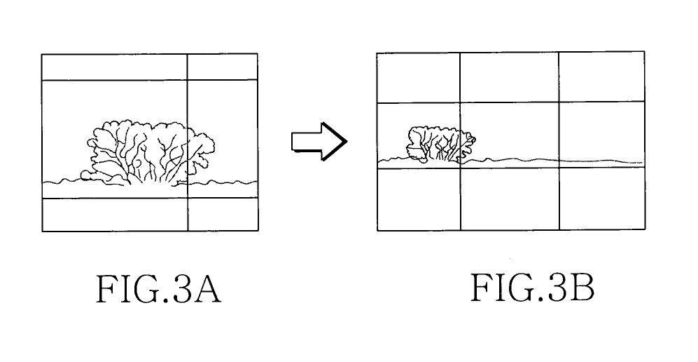

An example of automatically determining a photographing composition and, depending on the photographing composition, controlling a panning/tilting angle of a camera sensor in the aforementioned portable terminal according to the present invention is described below with reference to FIGS. 3 to 5.

FIGS. 3 to 5 illustrate picture compositions for photographed images in a portable terminal according to exemplary embodiments of the present invention.

If an image showing a tree on the plain is input by a user as illustrated in FIG. 3A, the portable terminal recognizes a photographing object through an image recognition algorithm, determines a photographing composition as a three-equal-part composition depending on the recognition result and, as illustrated in FIG. 3B, adjusts a panning/tilting angle of a camera sensor such that the tree is positioned near an intersection of horizontal and vertical lines for dividing a picture into three equal parts. At this time, it is undoubted that the portable terminal adjusts the panning/tilting angle of the camera sensor such that a background has the three-equal-part composition as well. Here, the three-equal-part composition refers to a composition in which a subject is positioned at an intersection of horizontal and vertical lines for approximately dividing a picture into three equal parts. It does not matter that the subject is positioned around the intersection, not just at the intersection.

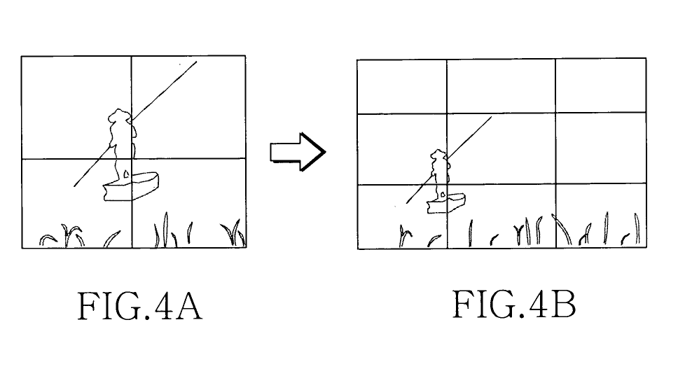

Next, if an image showing a fisher riding on a boat is input by a user as illustrated in FIG. 4A, the portable terminal recognizes a photographing object through an image recognition algorithm, determines a photographing composition as a three-equal-part composition depending on the recognition result and, as illustrated in FIG. 4B, adjusts a panning/tilting angle of a camera sensor such that the fisher is positioned around an intersection of horizontal and vertical lines for dividing a picture into three equal parts. At this time, it is undoubted that the portable terminal adjusts the panning/tilting angle of the camera sensor such that a background has the three-equal-part composition as well.

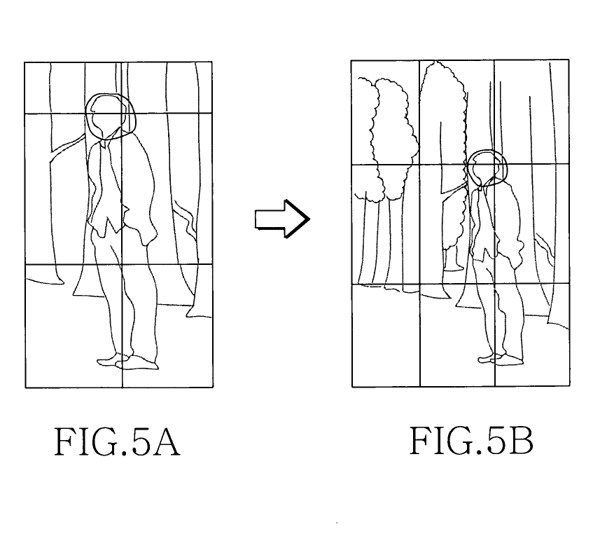

Lastly, if an image showing a character in a wood is input by a user as illustrated in FIG. 5A, the portable terminal recognizes a photographing object through an image recognition algorithm, and determines a photographing composition as a three-equal-part composition depending on the recognition result. At this time, the portable terminal recognizes a face direction of the character in the image and, depending on the face direction, determines a position of the character in the three-equal-part composition. That is, because the character faces the left, as illustrated in FIG. 5B, the portable terminal adjusts a panning/tilting angle of a camera sensor such that, in the three-equal-part composition, the character is positioned at a right intersection among intersections of horizontal and vertical lines for dividing a picture into three equal parts.

An exemplary embodiment of the present invention has an effect in which even users having no knowledge of photography automatically determine a photographing composition through image recognition, adjust a panning/tilting angle of a camera sensor adaptive to the determined photographing composition, and photograph an image, thereby being capable of taking a photograph of a high quality having a composition suitable to a subject in a portable terminal having a panning/tilting function.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for photographing an image in a portable terminal, the method comprising:
receiving an image from a camera;
recognizing the received image through an image recognition process;
determining a photographing composition corresponding to the recognition result; and
adjusting an angle of the camera depending on the determined photographing composition.

2. The method of claim 1, wherein adjusting the angle of the camera comprises:
setting a shift position of a subject shown in the received image depending on the determined photographing composition;
determining a sensor angle adjustment value of the camera depending on the shift position of the subject; and
adjusting a sensor angle of the camera depending on the determined angle adjustment value.

3. The method of claim 1, wherein the angle of the camera comprises at least one of a panning angle for adjusting a sensor angle of the camera left/right and a tilting angle for adjusting the sensor angle of the camera up/down.

4. The method of claim 1, further comprising:
if a subject is a character as the recognition result, recognizing a face direction of the character; and
setting a position of the character in the photographing composition depending on the face direction of the character.

5. The method of claim 1, further comprising: after adjusting the angle of the camera depending on the determined photographing composition, re-recognizing the received image through the camera of the adjusted angle; and
comparing if a photographing composition of the re-recognized image is consistent with the determined photographing composition.

6. The method of claim 5, further comprising one of:
if the photographing composition of the re-recognized image is consistent with the determined photographing composition, photographing an image; and
if the photographing composition of the re-recognized image is not consistent with the determined photographing composition, re-adjusting the angle of the camera.

7. The method of claim 1, wherein the photographing composition comprises at least one of a three-equal-part composition, an ‘S’-shaped composition, a triangle composition, a horizontal composition, a horizontal/vertical composition, and a diagonal composition.

8. An apparatus for photographing an image in a portable terminal, the apparatus comprising:
a camera configured to receive an image;
a controller configured to recognize the received image through an image recognition process and determine a photographing composition corresponding to the recognition result; and
an adjustment unit configured to adjust an angle of the camera depending on the determined photographing composition.

9. The apparatus of claim 8, wherein the controller is configured to set a shift position of a subject shown in the received image depending on the determined photographing composition, and determine a sensor angle adjustment value of the camera depending on the shift position of the subject, and
wherein the adjustment unit is configured to adjust a sensor angle of the camera according to the angle adjustment value determined in the controller.

10. The apparatus of claim 8, wherein the angle of the camera comprises at least one of a panning angle for adjusting a sensor angle of the camera left/right and a tilting angle for adjusting the sensor angle of the camera up/down.

11. The apparatus of claim 8, wherein, if a subject is a character as the recognition result, the controller is configured to set a position of the character in the photographing composition depending on a face direction of the character.

12. The apparatus of claim 8, wherein, after the angle of the camera is adjusted depending on the determined photographing composition, the controller is configured to re-recognize the received image through the camera of the adjusted angle, compare if a photographing composition of the re-recognized image is consistent with the determined photographing composition, photograph an image if they are consistent as the comparison result, and control the adjustment unit and re-adjusts the angle of the camera if they are not consistent as the comparison result.

13. The apparatus of claim 8, wherein the photographing composition comprises at least one of a three-equal-part composition, an ‘S’-shaped composition, a triangle composition, a horizontal composition, a horizontal/vertical composition, and a diagonal composition.

14. A portable terminal capable of photographing an image, the portable terminal comprising:
a camera configured to receive an image;
a controller configured to recognize the received image through an image recognition process and determine a photographing composition corresponding to the recognition result; and
an adjustment unit configured to adjust an angle of the camera depending on the determined photographing composition.

15. The portable terminal of claim 14, wherein the controller is configured to set a shift position of a subject shown in the received image depending on the determined photographing composition, and determine a sensor angle adjustment value of the camera depending on the shift position of the subject, and
wherein the adjustment unit is configured to adjust a sensor angle of the camera according to the angle adjustment value determined in the controller.

16. The portable terminal of claim 14, wherein the angle of the camera comprises at least one of a panning angle for adjusting a sensor angle of the camera left/right and a tilting angle for adjusting the sensor angle of the camera up/down.

17. The portable terminal of claim 14, wherein, if a subject is a character as the recognition result, the controller is configured to set a position of the character in the photographing composition depending on a face direction of the character.

18. The portable terminal of claim 14, wherein, after the angle of the camera is adjusted depending on the determined photographing composition, the controller is configured to re-recognize the received image through the camera of the adjusted angle and compare if a photographing composition of the re-recognized image is consistent with the determined photographing composition.

19. The portable terminal of claim 18, wherein the controller is configured to one of:
photograph an image if the photographing composition of the re-recognized image is consistent with the determined photographing composition; and
control the adjustment unit and re-adjusts the angle of the camera if the photographing composition of the re-recognized image is not consistent with the determined photographing composition.

20. The portable terminal of claim 14, wherein the photographing composition comprises at least one of a three-equal-part composition, an ‘S’-shaped composition, a triangle composition, a horizontal composition, a horizontal/vertical composition, and a diagonal composition.
